(19) United States
(12) Patent Application Publication
(10) Pub. No.: US 2025/0285375 A1
(43) Pub. Date: Sep. 11, 2025

(54) Automatic Generation of Floor Layouts

(71) Applicant: Smartplan AI, Inc., Chicago, IL (US)

(72) Inventors: Matthew Nicholas Lloyd, Chicago, IL (US); Danil Nagy

(21) Appl. No.: 18/860,770

(22) PCT Filed: Apr. 18, 2023
(86) PCT No.: PCT/US2023/018949

§ 371 Date: Oct. 28, 2024

Related U.S. Application Data
(60) Provisional application No. 63/336,449, filed on Apr. 29, 2022.

(51) Int. Cl. G06T 17/05; G06T 15/50; G06T 17/10; G06V 20/10

(52) U.S. Cl. CPC G06T 17/05; G06T 15/506; G06T 17/10; G06V 20/176; G06T 2200/24; G06T 2210/04

(57) ABSTRACT

Aspects described herein relate to the automatic generation of floorplan layouts based on a floorplan image. Image data comprising an image of an area may be accessed. Based on the image data, a floorplan of the area may be determined. A determination of whether constraints associated with occupancy are met may be made. Based on the constraints being met, and based on the floorplan, a light zones map may be generated. Based on the light zones map, spatial zones corresponding to the light zones may be determined. Based on the spatial zones, candidate floorplan layouts may be generated. Based on application of metaheuristic algorithms or machine-learning models to the candidate floorplan layouts, a subset of candidate floorplan layouts may be selected from the plurality of candidate floorplan layouts. Furthermore, floorplan layout data comprising a subset of floorplan layouts for use by a design application may be generated.

### RELATED APPLICATION

The present application claims the benefit of priority to U.S. Provisional Patent Application No. 63/336,449, filed Apr. 29, 2022, the entirety of which is incorporated by reference herein.

### TECHNICAL FIELD OF USE

Aspects of the disclosure relate generally to systems for generating floor layouts. More specifically, aspects of the disclosure may provide for the generation of floor layouts based on the use of metaheuristic algorithms and machine-learning models.

### BACKGROUND

Computing systems may be used to process information that is used as part of setting up an architectural space. For example, computer assisted design (CAD) programs may be used by architects to design the layout of an office space. However, CAD programs may have a steep learning curve, require specialized knowledge, and ultimately utilize a time-consuming process in which a ‘final’ layout is generated. This ‘final’ layout may not be to the liking of the client that commissioned the design and the design phase may either start again or the client may accept a design that is unsatisfactory. Additionally, the traditional design process may not take into consideration various aspects of the design that may be important to the end user including the comfort and habitability of the finished design. For example, the design may not allow for suitable levels of light or convenient traffic patterns. Further, the traditional design process is mainly manual and based on a potentially limited amount of design experience on the part of the architect.

As such, there may exist a demand for a system that provides a more effective way to design a layout based on a floorplan. Such a system would offer the benefits of a process in which many thousands of designs could be generated and winnowed down to a small number that would then be presented to the user. These thousands of designs could be based on previously performed analysis of layouts and this analysis could be refined in accordance with a user's preferences and any design constraints that may apply to the site of the design. Ideally, such a process would be performed quickly and automatically with the primary user input being the selection of a layout at the end of the process. Further, the process should facilitate the decision making part of the process by providing the user with a visualization representation of potential layouts.

### SUMMARY

Aspects of the disclosure address one or more of the drawbacks mentioned above by disclosing methods, computer readable media, and apparatuses associated with automatically generating design layouts as disclosed herein.

According to some aspects of the disclosure a computer-implemented method of automatically generating design layouts may be provided. The computer-implemented method may include accessing, by a computing device comprising one or more processors, image data comprising an image of an area. The computer-implemented method may include determining, by the computing device, based at least in part on the image data, a floorplan of the area. The computer-implemented method may include determining, by the computing device, whether the floorplan meets one or more constraints associated with occupancy of the area. The computer-implemented method may include, based on the floorplan meeting the one or more constraints, generating, by the computing device, based at least in part on the floorplan, a light zones map comprising a plurality of light zones associated with a distribution of light throughout the floorplan. Further, the computer-implemented method may include determining, by the computing device, based at least in part on the light zones map, a plurality of spatial zones associated with a plurality of dynamic zone types and corresponding to the plurality of light zones. The computer-implemented method may include determining, by the computing device, based at least in part on the plurality of spatial zones, a plurality of candidate floorplan layouts comprising different configurations of the plurality of spatial zones. The computer-implemented method may include selecting, by the computing device, based at least in part on application of one or more metaheuristic algorithms to the plurality of candidate floorplan layouts, a subset of candidate floorplan layouts from the plurality of candidate floorplan layouts. The genetic algorithm may be configured to select the subset of candidate floorplan layouts based at least in part on one or more criteria. Furthermore, the computer-implemented method may include generating, by the computing device, based at least in part on the subset of candidate floorplan layouts, floorplan layout data comprising a subset of floorplan layouts for use by a design application.

According to other aspects of the disclosure may include one or more non-transitory computer readable media comprising instructions that, when executed by at least one processor, cause a computing device to perform operations may be provided. The operations may include accessing image data comprising an image of an area. The operations may include determining, based at least in part on the image data, a floorplan of the area. The operations may include determining whether the floorplan meets one or more constraints associated with occupancy of the area. The operations may include, based on the floorplan meeting the one or more constraints, generating, based at least in part on the floorplan, a light zones map comprising a plurality of light zones associated with a distribution of light throughout the floorplan. Further, the operations may include determining, based at least in part on the light zones map, a plurality of spatial zones corresponding to the plurality of light zones. The operations may include determining, based at least in part on the plurality of spatial zones, a plurality of candidate floorplan layouts comprising different configurations of the plurality of spatial zones. The operations may include selecting, based at least in part on application of one or more metaheuristic algorithms to the plurality of candidate floorplan layouts, a subset of candidate floorplan layouts from the plurality of candidate floorplan layouts. The genetic algorithm may be configured to select the subset of candidate floorplan layouts based at least in part on one or more criteria. Furthermore, the operations may include generating, based at least in part on the subset of candidate floorplan layouts, floorplan layout data comprising a subset of floorplan layouts for use by a design application.

According to other aspects of the disclosure a system comprising: a computing device comprising: one or more processors; and memory storing instructions that, when executed by the one or more processors, cause the computing device to access image data comprising an image of an area. The computing device may determine, based at least in part on the image data, a floorplan of the area. The computing device may determine whether the floorplan meets one or more constraints associated with occupancy of the area. The computing device may, based on the floorplan meeting the one or more constraints, generate, based at least in part on the floorplan, a light zones map comprising a plurality of light zones associated with a distribution of light throughout the floorplan. Further, the computing device may determine, based at least in part on the light zones map, a plurality of spatial zones corresponding to the plurality of light zones. The computing device may determine, based at least in part on the plurality of spatial zones, a plurality of candidate floorplan layouts comprising different configurations of the plurality of spatial zones. The computing device may select, based at least in part on application of one or more metaheuristic algorithms to the plurality of candidate floorplan layouts, a subset of candidate floorplan layouts from the plurality of candidate floorplan layouts. The genetic algorithm may be configured to select the subset of candidate floorplan layouts based at least in part on one or more criteria. Furthermore, the computing device may generate, based at least in part on the subset of candidate floorplan layouts, floorplan layout data comprising a subset of floorplan layouts for use by a design application.

Aspects of the disclosure address one or more of the issues mentioned above by disclosing methods, non-transitory computer readable media, systems, devices, and apparatuses. In one example, the system may involve method steps disclosed herein. In another aspect of the disclosure, a system may communicate with or otherwise interact with one or more data stores as disclosed herein.

Aspects of the disclosure may be provided in a computer-readable medium having computer-executable instructions to perform one or more of the process steps described herein.

This summary is provided to introduce a selection of concepts in a simplified form that are further described below in the detailed description. The summary is not intended to identify key features or essential features of the claimed subject matter, nor is it intended to be used to limit the scope of the claimed subject matter. Moreover, one or more of the steps and/or components described above may be optional or may be combined with other steps.

### BRIEF DESCRIPTION OF THE DRAWINGS

Systems and methods are illustrated by way of example and are not limited in the accompanying figures in which like reference numerals indicate similar elements and in which:

FIG. 1 shows an illustrative operating environment in which various aspects of the disclosure may be implemented.

FIG. 2 is an illustrative block diagram of computing device that may be used to implement the processes and functions of certain aspects of the disclosure.

FIG. 3 is an illustration of a client workflow in accordance with certain aspects of the disclosure.

FIG. 4 is an illustration of using a floorplan in conjunction with a web form in accordance with certain aspects of the disclosure.

FIG. 5 is an illustration of processing information from a web form in accordance with certain aspects of the disclosure.

FIG. 6 is an illustration of daylight analysis in accordance with certain aspects of the disclosure.

FIG. 7 is an illustration of generating a zoning map in accordance with certain aspects of the disclosure.

FIG. 8 is an illustration of factors that are used by a metaheuristic algorithm to select a subset of candidate floorplan layouts in accordance with certain aspects of the disclosure.

FIG. 9 is an illustration of a data flow diagram in accordance with certain aspects of the disclosure.

FIG. 10 shows a flow diagram of automatic generation of layouts in accordance with certain aspects of the disclosure.

FIG. 11 illustrates a flowchart of receiving user input and training a machine-learning model.

### DETAILED DESCRIPTION

In light of the foregoing background, the following presents a simplified summary of the present disclosure in order to provide a basic understanding of some aspects of the concepts disclosed herein. This description is not an extensive overview of the invention. This description is not intended to identify key features or essential features of the claimed subject matter, nor is it intended to be used to limit the scope of the claimed subject matter. This description is provided to introduce a selection of concepts in a simplified form that are further described below. It is to be understood that other embodiments may be utilized and structural and functional modifications may be made.

The disclosed technology generally relates to the generation of layouts (e.g., architectural layouts) based on an input image that is processed by a computing system based on user preferences, layout constraints and the use of various techniques including the use of constraints based on user inputs, one or more metaheuristic algorithms, and/or machine-learning models. The disclosed technology offers a variety of technical effects and benefits including reducing the amount of time needed to generate a layout, providing an optimized layout based on the analysis of previous layout preferences and application of one or more metaheuristic algorithms to a set of layouts that meets certain layout constraints.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

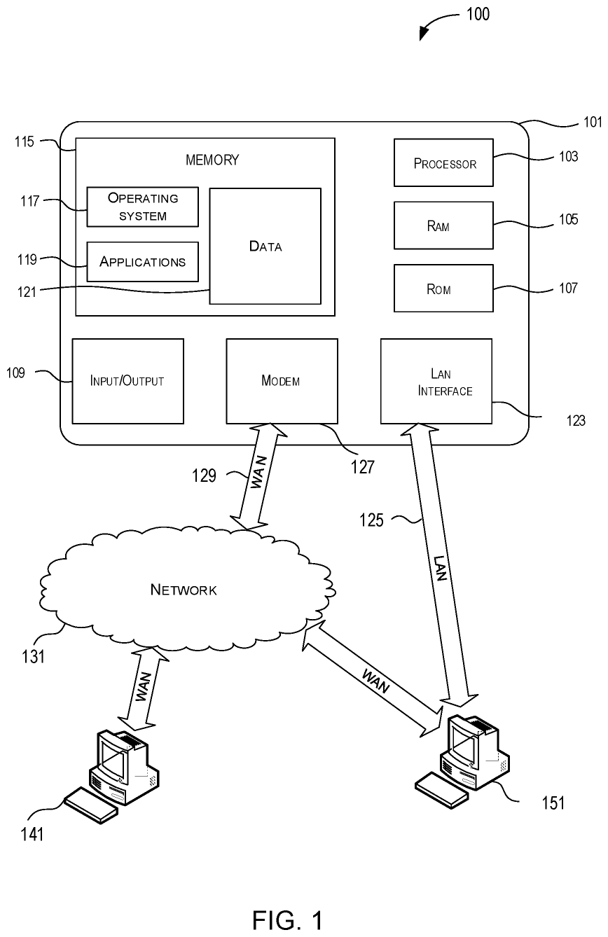

FIG. 1 illustrates a block diagram of a system 100 that may be used to implement one or more aspects of the present disclosure. The system 100 includes a computing device 101 (e.g., a server computing system) that may be used according to an illustrative embodiment of the disclosure. The computing device 101 may include one or more processors 103 for controlling overall operation of the computing device 101 and its associated components, including RAM 105, ROM 107, input/output module 109, and memory 115.

I/O 109 may include a microphone, keyboard, touch screen, mouse, camera, and/or stylus through which a user of computing device 101 may provide input, and may also include one or more speakers to provide audio output and a video display device for providing textual, audiovisual and/or graphical output. Software may be stored within memory 115 to provide instructions to one or more processors 103 for enabling computing device 101 to perform various functions. Further, the memory 115 may store instructions that, when executed by the one or more processors 103, cause the computing device to perform operations. In some embodiments, the memory 115 may store software used by the computing device 101, such as an operating system 117, application programs 119, and an associated database 121. The one or more processors 103 and associated components may allow the computing device 101 to run a series of computer-readable instructions to deploy program instructions according to the type of request that the computing device 101 receives. For instance, if a client computing device requests that program instructions for the generation of layouts based on an input image should be executed, computing device 101 may transmit the appropriate instructions to a user's computer when that user makes the request

The computing device 101 may operate in a networked environment supporting connections to one or more remote computers, such as workstations 141 and/or 151. The workstations 141 and/or 151 may be personal computers or servers that include many or all of the elements described above relative to the computing device 101. Alternatively, workstations 141 and/or 151 may be part of a “cloud” computing environment located with or remote from computing device 101 and accessed by computing device 101. The network connections depicted in FIG. 1 include a local area network (LAN) 125 and a wide area network (WAN) 129, but may also include other networks. When used in a LAN networking environment, the computing device 101 is connected to the LAN 125 through a network interface or adapter 123. When used in a WAN networking environment, the computing device 101 may include a modem 127 or other means for establishing communications over the WAN 129, such as the computer network 131. It will be appreciated that the network connections shown are illustrative and other means of establishing a communications link between the computers may be used. The existence of any of various well-known protocols such as TCP/IP, Ethernet, File Transfer Protocol (FTP), Hypertext Transfer Protocol (HTTP) and the like is presumed.

Additionally, an application program 119 used by the computing device 101 according to an illustrative embodiment of the disclosure may include computer executable instructions for invoking functionality related to delivering program instructions and/or content.

Computing device 101 and/or workstations 141 or 151 may also be mobile terminals including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, and distributed computing environments that include any of the above systems or devices, and the like.

The disclosure may be described in the general context of computer-executable instructions, such as program modules, being executed by a computer. Generally, program modules may include routines, programs, objects, components, and/or data structures, that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

Referring to FIG. 1, an illustrative system for implementing methods according to the present disclosure is shown. As illustrated, system may include one or more workstations 141, 151. Workstations 141, 151 may be local or remote, and are connected by one or more communications links to computer network 131. In certain embodiments, workstations 141, 151 may be different storage/computing devices for storing and delivering client-specific program instructions or in other embodiments workstations may be user terminals that are used to access a client website and/or execute a client-specific application. Computer network 131 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links may include any communications links that may be used for communication between workstations and server, such as network links, dial-up links, wireless links, hard-wired links, etc.

The steps that follow in the figures may be implemented by one or more of the components in FIG. 1 and/or other components, including other computing devices.

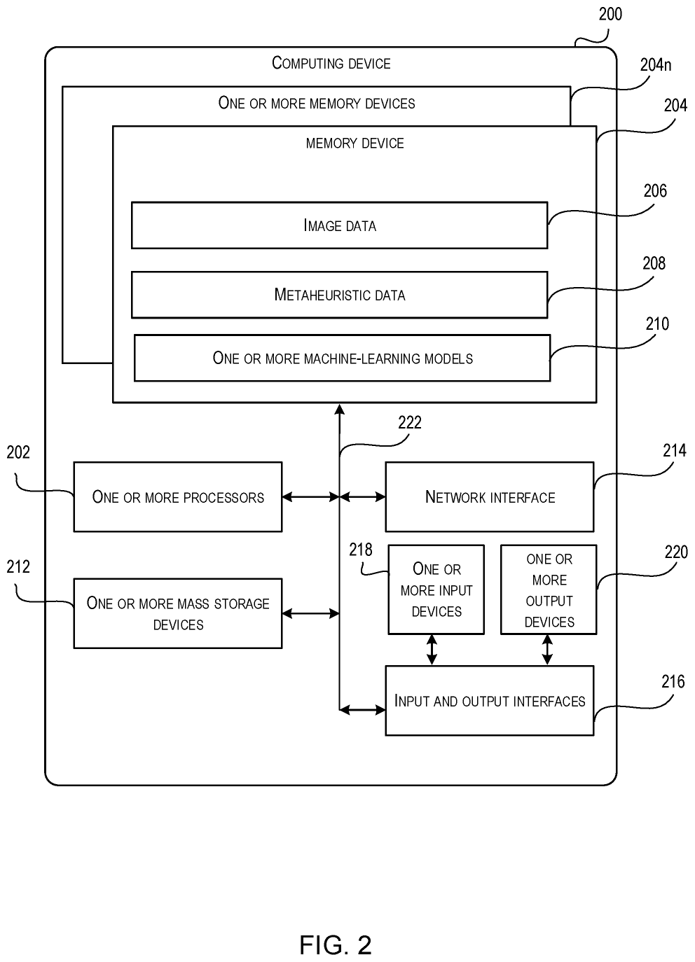

Any of the computing devices and/or systems described herein may be implemented, using any of the one or more computing devices described with respect to FIG. 2. The computing device 200 may include any of the features and/or capabilities of the computing device 101 that is illustrated in FIG. 1.

The computing device 200 may include one or more processors 202, one or more memory devices 204n, one or more mass storage devices 212, a network interface 214, input and output interfaces 216, one or more input devices 218, one or more output devices 220, and/or one or more interconnects 222. A memory device 204 of the one or more memory devices 204 may store the image data 206. The computing device 200 is not limited to the configuration illustrated in FIG. 2 and may include any number of processors, memory devices, mass storage devices, input and output interfaces, interconnects, and/or network interfaces. Further, any of the processors, memory devices, mass storage devices, input and output interfaces, interconnects, and/or network interfaces may be provided as any combination of separate components and/or as parts of the same component.

The one or more processors 202 may include one or more computer processors that are configured to execute one or more instructions stored in the one or more memory devices 204. The one or more processors 202 may include one or more general purpose central processing units, one or more application specific integrated circuits (ASICs), one or more graphics processing units (GPUs), and/or one or more field programmable arrays (FPGAs). Further, the one or more processors 202 may include single core devices and/or multiple core devices that may include one or more microprocessors, one or more microcontrollers, one or more integrated circuits, and/or one or more logic devices. In some embodiments, the one or more processors 202 may perform one or more operations to process the image data 206. For example, the one or more processors 202 may perform one or more operations comprising accessing the image data 206 and determining a floorplan based on the image data 206. The floorplan based on the image data 206 may be used to determine a plurality of candidate floorplan layouts to which one or more metaheuristic algorithms are applied in order to select a subset of the plurality of candidate floorplan layouts. The subset of candidate floorplan layouts may then be presented to a user.

The one or more memory devices 204 may store information and/or data (e.g., the image data 206). Further, the one or more memory devices 204 may include one or more non-transitory computer readable storage media, including RAM, ROM, EEPROM, flash memory devices, magnetic disks, and/or any of the memory devices described herein (e.g., the memory 112 illustrated in FIG. 1). The information and/or data stored by the one or more memory devices 204 may include instructions to perform one or more operations. Further, the instructions stored by the one or more memory devices 204 may be executed by the one or more processors 202. Execution of the instructions may cause the computing device 200 to perform one or more operations including the one or more operations described herein.

The one or more memory devices 204 and/or the one or more mass storage devices 212 are illustrated as separate entities in FIG. 2. However, the one or more memory devices 204 and/or the one or more mass storage devices 212 may occupy different portions of the same memory device. The one or more memory devices 204 and/or the one or more mass storage devices 212 may include one or more computer-readable media that may include but is not limited to non-transitory computer-readable media described above.

The one or more memory devices 204 may store instructions for use by one or more applications. The one or more applications may include an operating system that may be associated with various software applications and/or data. In some embodiments, the one or more memory devices 204 may store a general-purpose operating system that executes on the computing device 200. Further, the one or more memory devices 204 may store instructions that allow software applications to access data, including data associated with the image data 206.

The metaheuristic data 208 may store instructions associated with one or more metaheuristic algorithms (e.g., a genetic algorithm, simulated annealing algorithm, a particle swarm optimization algorithm, and/or a Monte Carlo algorithm) that may be implemented by the one or more processors 202. The metaheuristic data 208 may be stored in the memory device 204.

The one or more machine-learning models 210 may store instructions associated with one or more machine-learning models (e.g., convolutional neural networks) that may be implemented by the one or more processors 202. The one or more machine-learning models 210 may be stored in the memory device 204. In some embodiments, the one or more machine-learning models 210 may access external training data that may be used to configure and/or train the one or more machine-learning models 210. By way of example, the one or more machine-learning models 210 may comprise one or more convolutional neural networks, one or more recurrent neural network models (RNN), and/or one or more support-vector networks.

Further, one or more machine learning models 210 may be configured and/or trained using training techniques that may include supervised learning, unsupervised learning, semi-supervised learning, and/or reinforcement learning. The one or more machine learning models 210 may, for example, comprise parameters that have adjustable weights and fixed biases. As part of the process of configuring and/or training the one or more machine learning models 210, values associated with each of the weights of the one or more machine learning models 210 may be adjusted based on the extent to which each of the parameters contributes to increasing or decreasing the accuracy of output generated by the one or more machine learning models 210. For example, parameters of one or more machine learning models 210 may correspond to various visual features that are extracted from image data 206 and/or one or more constraints that are provided by a user. Over a plurality of iterations, and based on inputting training data (e.g., training data comprising images of floorplans and/or one or more user defined constraints) to one or more machine learning models 210, the weighting of each of the parameters may be adjusted based on the extent to which each of the parameters contributes to accurately generating candidate floorplans that meet the one or more constraints.

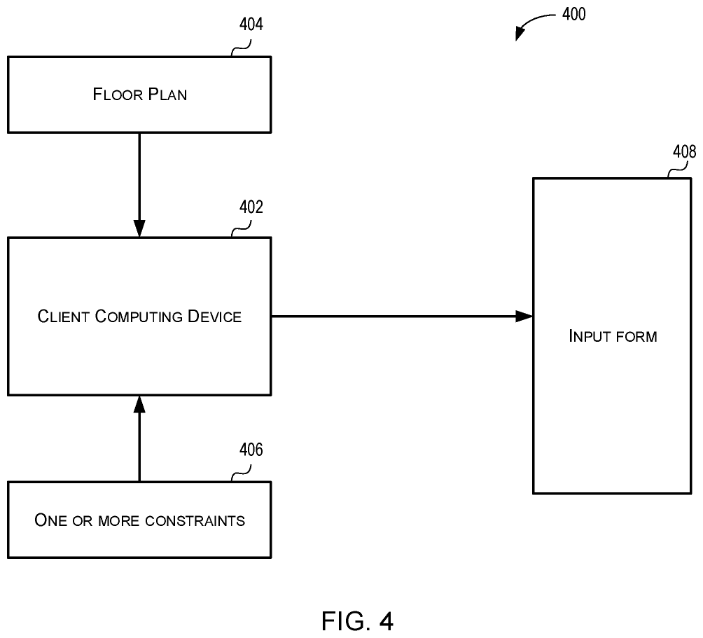

Training the one or more machine learning models 210 may comprise the use of a cost function that may be used to minimize the error between output of the one or more machine learning models 210 and a ground-truth value. For example, one or more machine learning models 210 may receive input comprising training data comprising images of the floorplans (e.g., the floorplan 404 described with respect to FIG. 4) described herein. Determination of the accuracy of output generated by the one or more machine learning models 210 may include generating candidate floorplans that are the same as or very similar to (e.g., within a predetermined range of similarity) one or more ground-truth floorplans. The accuracy of a candidate floorplan may be based on the similarity in features of the candidate floorplan to a ground-truth floorplan and may include an extent to which the one or more constraints are met. Inaccurate output by one or more machine learning models 210 may include generating candidate floorplans that are not the same as and/or are very dissimilar to (e.g., outside of a predetermined range of similarity) the one or more ground-truth floorplans. Over a plurality of training iterations, the weighting of the parameters of one or more machine learning models 210 may be adjusted (e.g., the weighting of parameters associated with accurate output may be increased and the weight of parameters associated with inaccurate output may be decreased) until the accuracy of the machine learning model's output reaches some threshold accuracy level (e.g., 95% accuracy). In some embodiments, the one or more machine-learning models 210 may be configured and/or trained to perform various operations including determining a floorplan of an area (e.g., the one or more machine-learning models 210 may perform image analysis techniques to determine a floorplan), generating a zoning map (e.g., the one or more machine-learning models 210 may perform daylight analysis as described herein), determine a plurality of spatial zones associated with a plurality of dynamic zone types, select a plurality of candidate floorplan layouts from a plurality of candidate floorplan layouts, and/or generating a subset of candidate floorplan layouts from the plurality of candidate floorplan layouts.

The software applications that may be executed by the computing device 200 may include applications associated with the computing system 100 that is illustrated in FIG. 1. Further, the software applications operated by the computing device 200 may include applications that operate locally and/or applications that are executed remotely (e.g., web applications that are executed on a server computing system with inputs received by the computing device 200 which may operate as a client device). For example, the computing device may implement applications including a design layout application that generates candidate floorplan layouts for a user based on factors including design constraints, the application of one or more metaheuristic algorithms, use of machine-learning models, and/or one or more user preferences.

The one or more interconnects 222 may include one or more interconnects or buses that may be used to send and/or receive one or more signals (e.g., electronic signals) and/or data (e.g., the image data 206) to and/or from one or more components of the computing device 200 (e.g., the one or more memory devices 204, the one or more processors 202, the one or more mass storage devices 212, the network interface 214, and/or the input and output interfaces 216). The one or more interconnects 222 may be configured and/or arranged in various ways including as parallel or serial connections. Further, the one or more interconnects 222 may include one or more internal buses to connect the internal components of the computing device 200; and/or one or more external buses to connect the internal components of the computing device 200 to one or more external devices. For example, the one or more interconnects 222 may include different interfaces including ISA, EISA, PCI, PCI Express, Serial ATA, Hyper Transport, and/or other interfaces that may be used to connect components of the computing device 200.

The one or more mass storage devices 212 may be used to store data including the image data 206, the metaheuristic data 208, and/or the one or more machine-learning models 210. The one or more mass storage devices 212 may include one or more solid state drives (SSDs), one or more hard disk drives (HDDs), and/or one or more hybrid drives including HDDs and SSDs.

The network interface 214 may support network connections including connections to communicate via one or more networks. The one or more networks to which the computing device 200 is connected via the network interface 214 may include a local area network, a wide area network, and/or the Internet.

The input and output interfaces 216 may include one or more input interfaces to receive input from the one or more input devices 218 and/or the one or more output devices 220. The one or more input device 218 may be used to provide one or more inputs to the computing device 200. The one or more input devices 218 may include one or more keyboards, one or more mouse devices, one or more touch input devices (e.g., a capacitive touch screen and/or a resistive touch screen), one or more microphones, and/or one or more cameras. The one or more output devices 220 may include one or more visual output devices (e.g., display devices including LCD displays and/or OLED displays) and/or one or more audio output devices (e.g., one or more loudspeakers).

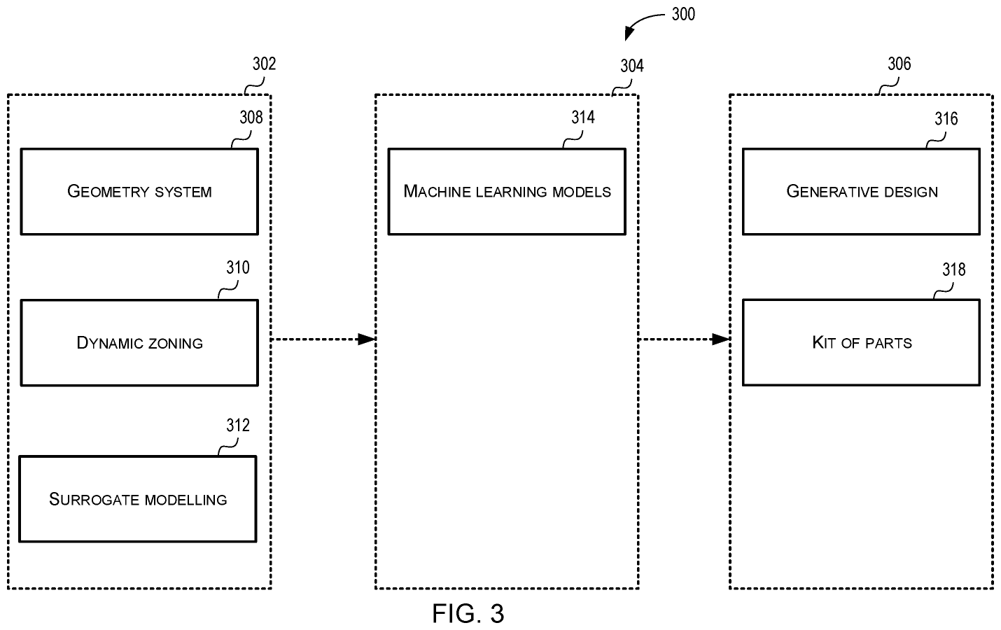

FIG. 3 is an illustration of a client workflow in accordance with certain aspects of the disclosure. The operations of the client workflow may be performed by a computing device as described herein (e.g., the workstation 141 that is described with respect to FIG. 1 and/or the computing device 200 that is described with respect to FIG. 2).

As shown in FIG. 3, operations 302 may be performed by a geometry system 308. The geometry system 308 may include a user interface (UI) that may be used to: collect input data, collect files, collect parameters, and/or interact with users and present layouts. The geometry system 308 may use a library (e.g., an external JS library) for rendering space-plans. Operations 302 may include the use of a back-end that may route requests, orchestrate the operations implemented by the system, manage communication between different parts of the system, perform logic operations, and/or prepare outputs. The geometry system 308 may perform image processing operations in which a floorplan image may be converted into a floorplan layout (e.g., a parametric model in order to automatically recognize features of the image. One or more image processing operations may include detection of wall, doors, windows, and/or other objects in order to generate a floorplan layout of the office.

Further, in operations 302 dynamic zoning operations 310 may be performed. Performance of dynamic zoning operations 310 may include daylight analysis and daylight simulation with respect to the floorplan. The dynamic zoning operations 310 may include the performance of daylight analysis and/or daylight simulation operations in preparation for operations 306. Daylight analysis may include determining a geographic location associated with a floorplan. The geographic location of the floorplan may be determined based on metadata included in the image (e.g., latitude, longitude, and/or altitude), a user provided input (e.g., an address associated with the image), and/or other data indicating the geographic location associated with the image. The daylight analysis may include a determination of the weather patterns of an area (e.g., precipitation in an area including expected rain or snow), cloud cover throughout the year, the latitude of the location, the orientation of the floorplan (e.g., where are windows of the floorplan relative to the Sun), and/or the locations of other buildings or natural formations around the area (e.g., is the floorplan in the shade of trees or another taller building).

In some embodiments, the dynamic zoning operations 310 may include daylight simulation in which the height of a ceiling, window sill, and/or mullions is used when determining the light that enters an area (e.g., the internal area associated with a layout). Further, the context in which a floorplan is located may affect the simulation of daylight. For example, a floorplan may be placed within a three-dimensional geographic context (e.g., at a particular latitude, longitude, and/or elevation) that may allow for more accurate modelling of the daylight at that particular location. Further, the geographic context may indicate the presence of buildings and other structures that influence (e.g., block light or reflect light) the way in which daylight may enter the layout.

Entry and/or egress points generated as part of the dynamic zoning operations 310 may be based on existing conditions and/or new conditions that may have been modified based on user input (e.g., the user may indicate preferred entry and/or egress points), and/or vectors that are cast from these entry and/or egress points, and at each point subdivided again to arrive at a series of circulation pathways or corridors. The dynamic zoning operations 310 may include the use of size constraints associated with the dimensions of various parts of the layout including corridor widths (e.g., compliance with standards including the Americans with Disabilities Act (ADA) standards), space type widths (the depth of each space type that can fit within a layout). The system may then generate a large number (e.g., thousands or millions) of layouts and the genetic algorithm may be used to narrow the number of layouts based on application of fitness criteria associated with the size constraints. The system may then determine three-dimensional space types that meet one or more criteria and/or any other criteria that may be specified by a user.

One or more surrogate modeling techniques 312 may be used as part of determining a zoning map (e.g., a light zones map and/or a functional zones map) and/or the plurality of candidate floorplan layouts. For example, sample areas within a geographical area can be modelled. Modelling these sample areas may include the application of spatial daylight autonomy as a metric for sufficient daylight illuminance (e.g., a minimum amount of light per given area for a certain period of time per day). Further, the sufficient daylight illuminance may be associated with a minimum illuminance level for specified operating hours per year, and/or an annual amount of sunlight exposure as a metric for potential visual discomfort owing to the direct sunlight.

Further, the density of buildings in the geographic area of the floorplan may be used as the basis for determining the amount of light that is available in the area. In some embodiments, a digital twin of an geographic area (e.g., a three-dimensional model corresponding to buildings in the geographic area) may be used to model the light that interacts with a candidate floorplan. For example, a digital twin may determine the amount of light that reaches a candidate floorplan and/or the amount of light that is reflected from the surface of nearby buildings.

After performing daylight analysis and determining the plurality of spatial zones, entry/egress points may be used to determine vectors associated with paths (e.g., corridors and/or hallways) between the spatial areas. The vectors may subdivide the spatial areas. The vectors may be constrained based in part on the width of the corridor and/or the space type depths (e.g., a range of depths from ten (10) to fifteen (15) feet). In some embodiments, a limit may be placed on the depth at which a vector (corridor) will not subdivide a spatial zone. For example, no subdivision of a spatial zone beyond a minimum of ten (10) feet of in any direction. After dividing the floorplan into a plurality of spatial zones, the spatial zones may be constrained based on user requirements/preferences and the dynamic zoning logic. The system may place space types based in part on the associated activity preference (work zone, team zone, community zone).

In some embodiments, the location of entry/exit points may be used to determine the location of various areas. For example, drive the location of an main entry may be used to determine the location of a reception area. In some embodiments, users may label wet areas within the floorplan and the location of the wet areas may be used to determine the placement of a kitchen within a wet area. Further, users may draw in and label existing spatial zones that they wish to retain within the floorplan. The system may then determine the spatial zones accordingly.

The placement of spatial zones may be optimized based on one or more view constraints. The one or more view constraints may include views from the interior of the floorplan to an area outside the floorplan. The one or more view constraints may be based on vectors from the midpoint of a spatial zone to the nearest window. The one or more view constraints may be used to ensure that a view from inside the floorplan to the area outside the floorplan is available and/or that the view provides some minimum level of daylight and/or complies with other criteria.

The daylight simulation operations may include simulating daylight in the floorplan at different times of the day and/or the year. For example, the daylight simulation operations may include generating a three dimensional model based on the floorplan with simulated light radiating from the position of a simulated Sun. In some embodiments, one or more ray tracing techniques may be used to determine the amount of light that is reflected off of different surfaces within the simulated floorplan. Further, the daylight simulation operations may take into account the locations of transparent surfaces (e.g., internal and external windows), reflective surfaces (e.g., mirrors), and semi-opaque surfaces (e.g., frosted glass) in the determination of the amount of light that is cast throughout the floorplan. In some embodiments, the daylight simulation may simulate different models of daylight on the floorplan based on different window configurations (e.g., windows with curtains, windows with blinds, and/or windows that do not have any type of covering). In some embodiments, a transformation web service may transform the outputs of the image processing operations to the appropriate format of inputs for the generative design system.

Operations 304 may include the use of one or more machine-learning models 314. The one or more machine learning models 314 may implement a policy network that may imitate and learn from previously analyzed floorplans. In some embodiments, the one or more machine-learning models 314 may include a value network that evaluates any layouts against a training set. Further, in some embodiments, the one or more machine learning models 314 may use a tree search to identify more optimal layouts. The one or more machine-learning models 314 may be configured and/or trained using a training dataset that may comprise a plurality of labeled floorplans and/or corresponding images. The use of the training dataset by the one or more machine-learning models 314 may enhance performance during the generative design phase with a trained, experienced floorplan model versus starting from scratch each time and evolving the designs through iterations. The machine learning phase attempts to save time in the long run by already understanding some of the key and unknown elements of design. Training workflow suggested below.

Operations 316 may include a generative design system. The generative design system may use a plurality of metrics as part of determining candidate floorplan layouts for a user to select. The generative design system may use various metaheuristic algorithms that may perform operations including: generation of space data (geometries, program of space, position of utilities including plumbing, electrical lines, water lines, and/or ventilation); evaluation of each metric; production of all solutions meeting the user's requirements/preferences (e.g., a brute force technique); and evolving in order to analyze and select a layout.

The kit of parts 318 may indicate a variety of different space types and/or client space type requirements. A client may input the space types to include an office design. The kit of parts 318 may indicate key space types which make up an office space; workstations, team rooms, huddle rooms, focus rooms, and offices. These space types may be allocated a square foot ratio or square meter ration which have been used in other projects in the past.

FIG. 4 is an illustration of using a floorplan in conjunction with a web form in accordance with certain aspects of the disclosure. The operations of the client workflow may be performed by a computing device as described herein (e.g., the workstation 141 that is described with respect to FIG. 1 and/or the computing device 200 that is described with respect to FIG. 2).

As shown in FIG. 4, a client computing device 402 may be used to access and/or generate a floorplan 404, one or more constraints 406, and/or an input form 408. For example, the client computing device 402 may access floorplan data (e.g., data that includes a floorplan and/or blueprints) and/or input parameters (e.g., one or more constraints that may be used to limit output that is generated) that are stored locally (e.g., on a storage device of the client computing device 402) or on a remote storage device that may be accessed via a network (e.g., the network 131 described with respect to FIG. 1). The client computing device 402 may analyze the floorplan 404 and/or one or more constraints 406. For example, the client computing device 402 may parse input parameters associated with the one or more constraints. The input parameters may indicate user preferences and/or requirements for a floorplan layout. By way of further example, the client computing device 402 may perform operations to process an image of a floorplan (e.g., an image file) and determine the dimensions and proportions of the floorplan.

The floorplan 404 may be based on image data that may be processed by the client computing device 402 in order to determine the features (e.g., spatial features) of a floorplan that is provided as input. For example, the client computing device 402 may perform image processing operations in which image data including a floorplan image may be converted into a parametric model in order to automatically recognize features of floorplan in the image data. Using one or more computer vision techniques, the image processing operations may include detection of one or more walls, one or more doors, one or more windows, and/or one or more objects that are indicated within the floorplan 404. In some embodiments, the client computing device 402 may use the floorplan 404 to generate a parametric model based on the floorplan that was processed.

The one or more constraints 406 may include an employee count (e.g., a number of employees that may be expected to work within an area defined by a floorplan), program requirements/preferences (e.g., preferred locations of a kitchen, bathrooms, conference rooms, and/or hallways), the location of the area (e.g., the geographic location within which the floorplan may be generated), and a preferred space per employee (e.g., a number of square feet that may be designated to each employee that may use the area defined by the floorplan).

The information and/or data associated with the floorplan 404 and/or the one or more constraints 406 may be included in the input form 408. In some embodiments, the floorplan 404 and/or the one or more constraints may be provided via the input form 408. For example, a user may enter the one or more constraints into a form using a user interface that allows the user to select a number of bathrooms, offices, and/or conference rooms that may be included in a floorplan. Further, a user may use the form to upload image files that may include a floorplan. The input form 408 (e.g., a web form that is accessible via the Internet or an intranet) may be configured to receive the floorplan 404 and/or the one or more constraints 406. Further, the input form 408 may comprise a front-end for the computing systems that process the floorplan 404 and/or the one or more constraints 406 as part of generating a plurality of candidate floorplan layouts.

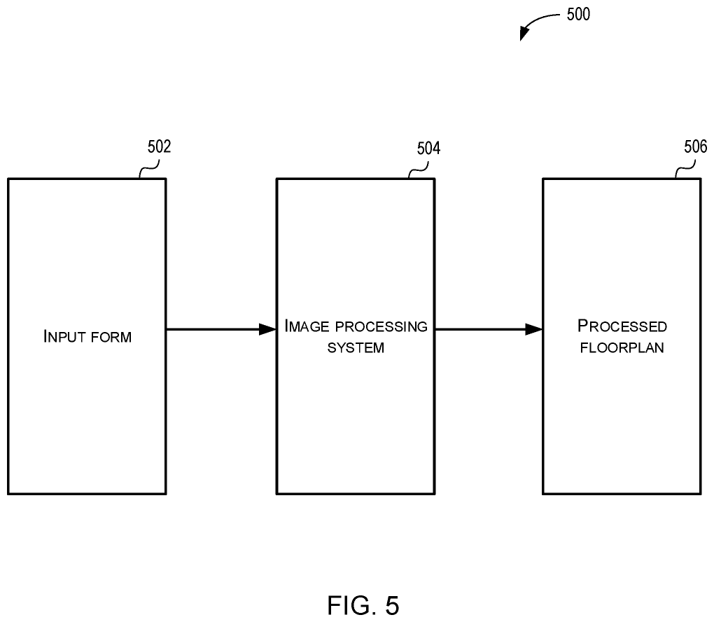

FIG. 5 is an illustration of processing information from an input form in accordance with certain aspects of the disclosure. The operations of the client workflow may be performed computing device as described herein (e.g., the workstation 141 that is described with respect to FIG. 1 and/or the computing device 200 that is described with respect to FIG. 2).

As shown in FIG. 5, an input form 502 (e.g., an input form with the features of the input form 408 described with respect to FIG. 4) and/or information associated with the input form may be sent to image processing system 504 (e.g., a computer vision system) that may be configured to recognize the floorplan included in the input form 502. In some embodiments, the image processing system may use one or more machine-learning models to detect and/or recognize one or more features of the floorplan. Further, the image processing system 504 may digitize the floorplan indicated in the input form 502. Digitization of the floorplan may include converting the raw image data that is included in the input form 502 into a form that includes information including the locations of doors, windows, and/or hallways. Further, the processed floorplan 506 may include dimensions (e.g., dimensions in meters) of the area indicated in the input form 502. In some embodiments, the floorplan included in the input form 502 may include data indicating the dimensions of the area indicated in the floorplan.

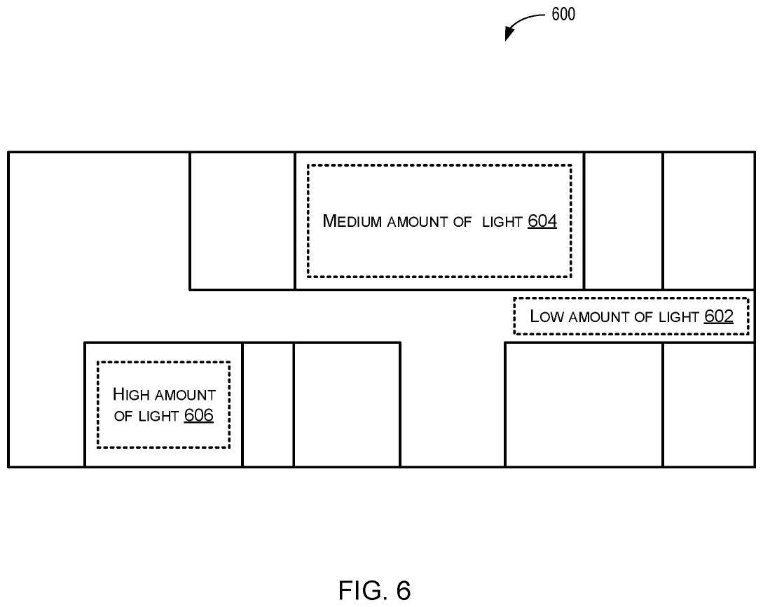

FIG. 6 is an illustration of daylight analysis in accordance with certain aspects of the disclosure. The operations of the client workflow may be performed computing device as described herein (e.g., the computing device 200 that is illustrated in FIG. 2).

As described with respect to FIG. 6, a system may perform daylight analysis based on an input (e.g., the input form 408 described with respect to FIG. 4) that may include a floorplan and/or a layout. The daylight analysis may determine an amount of daylight and/or artificial light that is received by different portions of a layout throughout the day and at different times of the year. Daylight analysis may include an analysis of a floorplan to determine an amount of daylight associated with spaces (e.g., rooms and/or hallways) indicated in a floorplan (e.g., the floorplan 404 described with respect to FIG. 4). The spaces indicated in the floorplan may be determined based on the use of the techniques described herein including the application of one or more metaheuristics and/or one or more machine-learning models to an input form (e.g., the input form described with respect to FIG. 4) and/or the floorplan and/or one or more constraints included in the input form. For example, the daylight analysis may use the locations of windows, entrances, and/or doors to determine an amount of light that may enter into an area at different times of day. The daylight analysis may also use the color and/or reflectivity of walls and/or floors to determine the amount of daylight that may be in an area at different times of day. The daylight analysis may group the spaces indicated in the floorplan into primary space (e.g., spaces with high levels of light), secondary space (e.g., spaces with medium levels of light), tertiary space (e.g., spaces with low levels of light), and a building core space (e.g., a space that does not receive natural light). In this example, a high amount of light may be determined to be received in the space 606, which may be determined to be an office space, a medium amount of light may be determined to be received in space 604, which may be determined to be a focus room, and a low amount of light may be determined to be received in space 602 which may be determined to be a copy space.

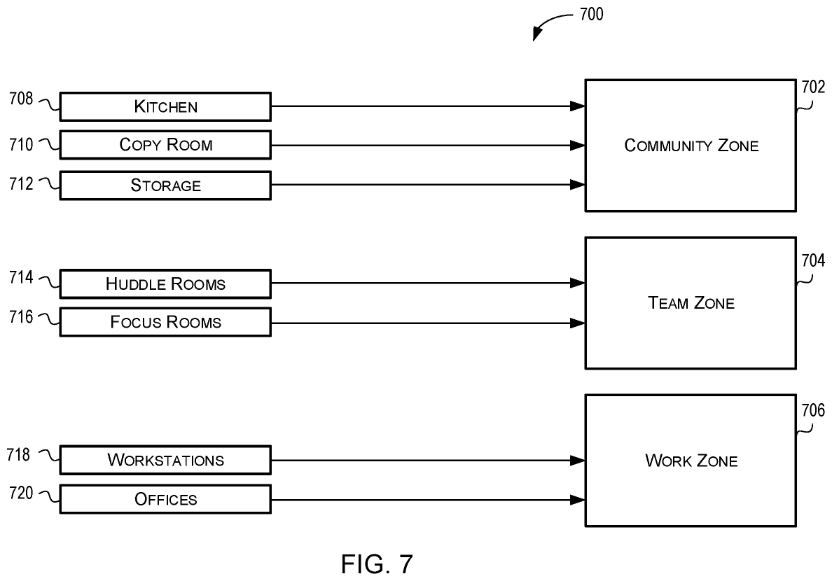

FIG. 7 is an illustration of generating a zoning map in accordance with certain aspects of the disclosure. The operations of the daylight analysis described with respect to FIG. 7 may be performed by a computing device as described herein (e.g., the workstation 141 that is described with respect to FIG. 1 and/or the computing device 200 that is described with respect to FIG. 2).

As shown in FIG. 7, the spaces include kitchen space 708, copy room space 710, storage space 712, huddle rooms 714, focus rooms 716, workstations 718, and offices 720. After determining the spaces in the floorplan, the spaces may be associated with a plurality of zones. The plurality of zones may be associated with amounts of daylight that spaces are determined to receive. For example, the amounts of daylight received by the spaces may be based on daylight analysis described herein. Determining a plurality of zones may comprise determining a plurality of light zones. The plurality of light zones may comprise one or more community zones 702, one or more team zones 704, and/or one or more work zones 706. One or more community zones 702 may comprise spaces with low levels of light. In this example, one or more community zones 702 may include the kitchen space 708, the copy space 710, and storage space 712. The one or more community zones 702 may correspond to portions of the floorplan and/or layout in which employees and visitors arrive. The determination of which spaces are included in the one or more community zones 702 may be performed such that spaces in which noise and movement around the entrance to the space are contained within the one or more community zones 702.

The one or more team zones 704 may be associated with spaces that receive an intermediate amount of light. The one or more team zones 704 may include the huddle rooms space 714 and/or focus rooms space 716. The team zone 704 may be distributed evenly across the floorplan and/or layout, and may be within close proximity to the dynamic work zones where possible. The team zone 704 may be associated with

The one or more work zones 706 may be associated with spaces that receive a high level of light. The one or more work zones 706 may be located near the perimeter of the floorplan and/or layout, so that there is access to the most natural light and so that the one or more work zones 706 are further away from noisy high traffic areas

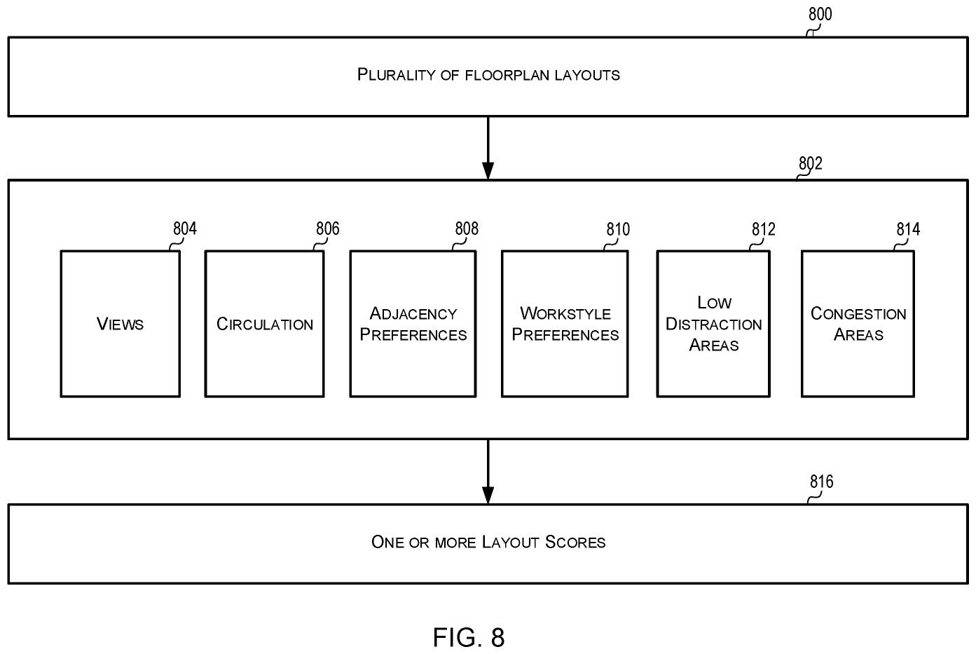

FIG. 8 is an illustration of factors that are used by a metaheuristic algorithm to select a subset of candidate floorplan layouts in accordance with certain aspects of the disclosure. The factors used by a metaheuristic algorithm may be processed using a computing device as described herein (e.g., the workstation 141 that is described with respect to FIG. 1 and/or the computing device 200 that is described with respect to FIG. 2).

A system may use one or more metaheuristic algorithms 800 to generate one or more layout scores 816 that are based on the layout factors 804-812 and a plurality of candidate floorplan layouts. The layout factors 804-812 may include a views factor 802 (e.g., views from inside a building to an area outside the building), a circulation factor 806, an adjacency preferences factor 808, a workstyle preferences factor 810, a low distraction area preferences factor 812 (e.g., a number and/or size of low distraction areas), and/or a congestion factor 814.

The layout factors 804-812 may be weighted and the one or more layout scores that are generated by the one or more metaheuristic algorithms may be used to select a subset (e.g., three or four floorplan layouts) of candidate floorplan layouts from a plurality of candidate floorplan layouts that includes a larger number of candidate floorplan layouts (e.g., one thousand floorplan layouts). The layout factors 804-812 may be used to generate a layout score for each of the plurality of candidate floorplans. For example, the one or more layout scores 816 may be generated through the application of a genetic algorithm to the plurality of candidate floorplan layouts. The subset of candidate floorplan layouts with the highest scores may be provided to the user and the user may select one or more preferred layouts from the subset of candidate floorplan layouts.

The one or more metaheuristic algorithms may evaluate the views 804 and generate a layout score based in part on a number of views to an outdoor environment, the locations of windows and walls within the floorplan, and/or a size of a view to an outdoor environment. Further, the views 802 may be scored based on what is visible from a particular viewpoint (e.g., a forest or the side of another building). Further, the determination of the views 804 may be based on the potential locations of objects (e.g., shelves) that may obstruct the view of the exterior of a building. Further, the one or more metaheuristic algorithms may evaluate an extent to which a view through a window is unobstructed by external objects including buildings and/or trees. The plurality of candidate floorplan layouts that include a greater number of spatial zones in closer proximity to windows, with fewer internal obstructions and/or external obstructions may be more likely to be associated with a higher layout score. The one or more layout scores 816 may be positively correlated with a more expansive view and/or a view that includes more natural elements (e.g., a view of a forest or lake). The one or more layout scores 816 may be inversely correlated with a more restrictive view (e.g., a view hemmed in by other buildings) and/or a view that includes fewer natural elements (e.g., a view of a cement parking lot).

The one or more metaheuristic algorithms 802 may evaluate the circulation 806 and generate a layout score based in part on an amount and type of circulation through the floorplan layout. Circulation may be associated with foot traffic and/or airflow. For example, certain portions of a floorplan (e.g., a lobby at a main entrance) may have a greater circulation of foot traffic than a portion of a floorplan in a corner near a storage room. By way further example, a portion of a floorplan that is near an entrance and/or windows may have a greater amount of air circulation than a portion of the floorplan near a windowless bathroom that is in an interior portion of a floorplan. With respect to circulation, the one or more layout scores 816 may be based in part on whether the layout meets one or more occupancy criteria. The one or more occupancy criteria may be associated with one or more building codes and/or building standards (e.g., International building codes and/or accessible design standards). For example, the one or more occupancy criteria may include the locations and/or number of emergency exits, the width of corridors, and/or the location of stairwells. The one or more layout scores 816 may be positively correlated with wider hallways, larger rooms, and/or higher ceilings. Further, the one or more layout scores 816 may be positively correlated with ventilation ducts, windows, entrances, and/or exits. greater circulation. The one or more layout scores 816 may be inversely correlated with narrower hallways, smaller rooms, and/or low ceilings. Further, the one or more layout scores 816 may be inversely correlated with a distance from ventilation ducts, windows, entrances, and/or exits.

The one or more metaheuristic algorithms 802 may evaluate the adjacency preferences 808 and generate a layout score based in part on an extent to which a floorplan layout conforms to adjacency preferences (e.g., adjacency preferences indicated by a selector of a layout). Adjacency preferences may comprise preferred locations of workspaces relative to other workspaces (e.g., offices), bathrooms, entrances, exits, and/or other types of workspaces (e.g., conference rooms and/or collaborative spaces). The one or more layout scores 816 may be positively correlated with a similarity in the relative position of workspaces to the relative position of workspaces within a floorplan layout.

The one or more metaheuristic algorithms 802 may evaluate the workstyle preferences 810 and generate a layout score based in part on an extent to which a floorplan layout conforms to a workstyle preference (e.g., a workstyle preference indicated by a selector of a layout). Workstyle preferences may comprise team oriented workstyle preferences with a greater number of meeting rooms or collaborative spaces, more individualized workstyle preferences with a greater number of individual offices, an open space workstyle preference with a minimum number of walls, or various hybrid workstyle preferences that may combine different types of workstyle preferences. The one or more layout scores 816 may be positively correlated with a similarity in the number of rooms, room size, and/or spatial relationships between workspaces within a floorplan layout.

The one or more metaheuristic algorithms 802 may evaluate the low distraction areas factors 812 and generate a layout score based in part on a number areas of a floorplan layout that are associated with low distraction. The one or more layout scores 816 may be positively correlated with distance from entrances, exits, windows that are openable, bathrooms, and high circulation areas. The one or more layout scores 816 may be inversely correlated with close proximity to entrances, exits, windows that are openable, bathrooms, and high circulation areas.

The one or more metaheuristic algorithms 802 may evaluate the congestion factors 814 and generate a layout score based in part on congestion in various areas of a floorplan layout. With respect to congestion, the amount of congestion may be based on the function and/or placement of a spatial zone. For example, spatial zones in which individuals may tend to congregate (e.g., a break room with a water cooler and coffee maker) may have more congestion than other spatial zones. Further, spatial zones including hallways that lead to main entrances/exits may tend to have more congestion than other spatial zones. The system may include constraints on the amount of congestion that is acceptable such that the movement of individuals through a layout is within some predetermined limits. The one or more layout scores 816 may be inversely correlated with an estimated amount of congestion in an area.

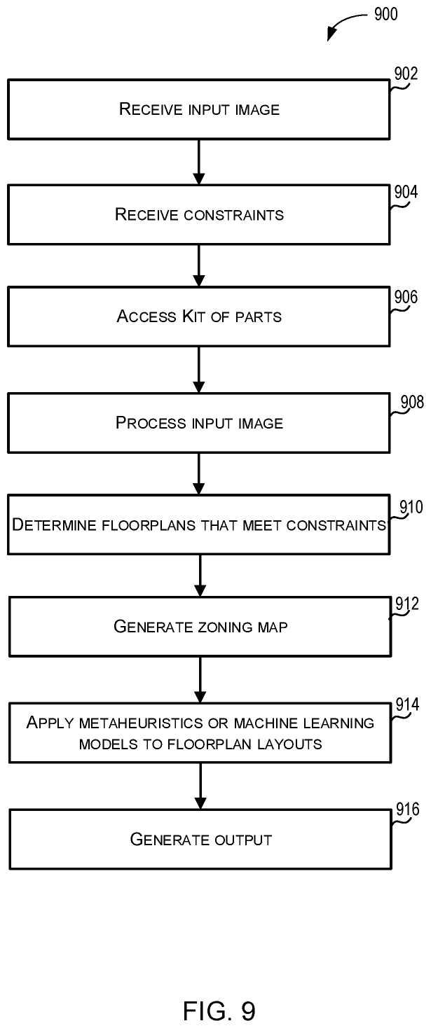

FIG. 9 is an illustration of a data flow diagram in accordance with certain aspects of the disclosure. The operations of the client workflow may be performed computing device as described herein (e.g., the workstation 141 that is described with respect to FIG. 1 and/or the computing device 200 that is described with respect to FIG. 2).

At step 902, an input image (e.g., image data) may be received. The input image may be used to generate a floorplan layout. For example, a client may upload the plan via a web form that is associated with a backend computing device that may process the input image The input image may be encoded in a variety of image formats including JPG, PNG, TIFF, BMP, or PDF.

At step 904, after the plan has been received, one or more constraints (e.g., constraints associated with a preferred office space) may be received. The one or more constraints may include an employee count, space requirements, space preferences, a location constraint, an address constraint, an orientation of the location, and/or an amount of space per employee.

At step 906, a kit of parts that includes the space types that may be used in a floorplan layout may be accessed. The kit of parts may be used to define space types including a focus room, a huddle room, offices, workstations, storage, a copy room, and/or a kitchen),

At step 908, the input image may be processed. For example, features of the input image may be processed (e.g., using a machine learning model configured to recognize walls, doors, windows, and/or hallways) and a floorplan may be generated based on the input image.

At step 910, floorplans that meet the one or more constraints may be generated and/or determined. For example, the one or more constraints may comprise a space per employee constraint. The space per employee constraint may be multiplied by a number of employees to determine a minimum amount of space for a floorplan that is generated and/or determined.

At step 912, a zoning map may be generated. Generation of a zoning map may comprise daylight analysis of the area included in the floorplan and/or analysis of functional areas and/or functional elements within a floorplan. Daylight analysis may include, segmenting the floorplan into a plurality of daylight zones including primary space (high levels of light); secondary space (medium levels of light); tertiary space (low levels of light); and building core space (inner spaces of a building that receive negligible levels of natural light).

Generation of a zoning map may be based on workstyle preferences. Workstyle preferences may be applied to a floorplan based on the determination of a plurality of spatial zones that may be based on the daylight zones. The plurality of spatial zones may include a primary space that includes a dynamic work zone with high levels of light, a secondary space for dynamic teams with medium levels of light, a tertiary space, and building core space that has dynamic community zones and low levels of light. For example, the plurality of spatial zones may each be assigned space such that dynamic work zones (corresponding to high levels of light) may include workstations for one (1) person and individual offices; the dynamic team zones (corresponding to medium levels of light) may include a huddle room (four to five people), a focus room (one or more two people), team rooms (twelve (12) or more people); and the dynamic community zones (corresponding to low levels of light) may include storage space, a kitchen, bathroom facilities, and/or a copy room.

Generation of a zoning map may be based on adjacency preferences. Adjacency preferences may be applied to a floorplan based on the application of one or more zoning rules. The one or more zoning rules may be applied to determine the relative locations of the plurality of spatial zones within the floorplan. Further, the one or more zoning rules may be associated with the adjacency of zoning areas, the proximity of zoning areas to other zoning areas, the size of clusters of zoning areas, and/or the distribution of the different types of zoning areas. The zoning rules associated with the adjacency of zoning areas may include limits on the types of zoning areas that may be adjacent. For example, the zoning rules may prevent dynamic work zones including offices from being adjacent to dynamic community zones including break rooms. The zoning rules associated with the proximity of zoning areas to other zoning areas may include minimum distances between different types of zoning areas. For example, the zoning rules may prevent dynamic work zones including offices from being within a certain distance of dynamic team zones including conference rooms. Further, the zoning rules associated with the size of clusters of zoning areas may include limits on the number of the same type of zoning area that are clustered together. For example, the zoning rules may prevent more than three (3) dynamic team zones (e.g., meeting rooms) from being clustered together. Further, the zoning rules associated with the distribution of the different types of zoning areas may attempt to allocate certain types of zoning areas throughout the floorplan. For example, if the zoning areas include two (2) dynamic community zones including bathroom facilities the system may distribute the dynamic community zones to opposite ends of the floorplan and/or prevent the dynamic community zones from being next to one another.

Generation of a zoning map may be based on workstyle preferences. Circulation preferences may be applied to a floorplan based on the application of one or more zoning rules. The one or more zoning rules may be applied to determine the movement of foot traffic and/or air within the floorplan. Further, view preferences may be applied to a floorplan based on the application of one or more zoning rules. For example, the one or more zoning rules may be applied to determine the relative locations of windows within the floorplan. Additionally, low distraction preferences may be applied to a floorplan based on the application of one or more zoning rules. The one or more zoning rules may be based on an estimated amount of distraction (e.g., noise and/or foot traffic) within a zone and may be applied to determine the relative locations of offices and other workspaces within the floorplan.

The zoning map may be based on the location of functional zones within a floorplan. The functional zones may comprise the location of plumbing pipes, electrical lines, water lines, and/or ventilation ducts throughout a floorplan. The functional zones may be used to determine the space types within a floorplan. For example, a kitchen may be positioned at a location with electrical lines that support kitchen appliances and a bathroom may be positioned at a location with plumbing lines.

At step 914, one or more metaheuristic algorithms and/or machine learning models may be applied to the floorplan layouts. The one or more metaheuristic algorithms may comprise one or more evolutional techniques that may mutate the floorplan layouts to generate more efficient and/or optimized floorplan layouts, as well as narrowing down the options to arrive at a subset of candidate floorplan layouts (e.g., one to three optimized layout variations). In some embodiments, the one or more evolutional techniques may comprise use of a genetic algorithm (e.g., a multi-objective genetic algorithm). The genetic algorithm may process the information so that the fittest floorplan layouts are selected. In some embodiments, the system may iteratively repeat the steps of the one or more evolutional techniques to refine and evolve the floorplan layout (e.g., the layout based on the floorplan of the area). In some embodiments, the system may use machine-learning models that are configured and/or trained to receive input including an image of the area or a floorplan and generate output including the candidate floorplan layouts.

At step 916, output including floorplan layout data may be generated. The output may include one or more visual space plans, renders, and/or a three-dimensional model of the candidate floorplan layouts which may be presented to a user for the user's final approval of a particular layout or for further refinement of the floorplan layout.

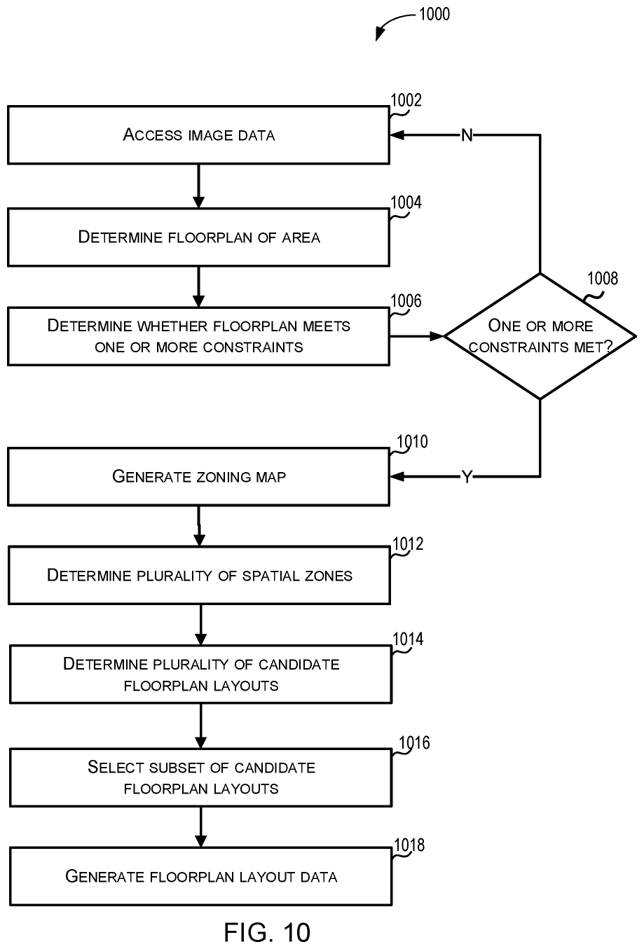

FIG. 10 illustrates a flowchart of an example method 1000 to automatically generate floor layouts. The method 1000 may be performed by any suitable computing device (e.g., the workstation 141 that is described with respect to FIG. 1 and/or the computing device 200 that is described with respect to FIG. 2) and/or combination of computing devices, and is referred to herein as the system implementing the method 1000.

At 1002, the system may access, receive, retrieve, and/or obtain image data that may comprise an image of an area. The image may comprise one or more photographic images, one or more images that are automatically generated (e.g., a computer generated rendering of an area), and/or one or more images that are manually generated (e.g., a hand drawn image or blueprint of an area). For example, the system may access image data comprising an image (e.g., a user provided image) of an area inside an apartment building, house, or commercial building. Further, the image data may include geographic coordinates and/or information associated with the orientation of the area.

At 1004, the system may determine based at least in part on the image data, a floorplan of the area. In some embodiments, determining the floorplan of the area may be based at least in part on application of one or more object detection techniques to the image data. For example, the image data may be provided as an input to a machine-learning model that is configured and/or trained to generate a floorplan based on input comprising the image data. By way of further example, the one or more object detection techniques may comprise use of scale invariant feature transform (SIFT) to locate features indicated in the image data. The one or more object detection techniques may be configured to detect one or more objects that may comprise one or more walls, one or more doors, and/or one or more windows.

At 1006, the system may determine whether the floorplan meets one or more constraints. The constraints may be associated with occupancy of the area (e.g., the types of rooms and/or individuals that may occupy the area associated with the floorplan). Additionally, the one or more constraints may be associated with an amount of light that is requested for various areas within the floorplan, sound levels within various areas within the floorplan, and/or congestion and traffic flow within the floorplan. In some embodiments, the one or more constraints may be used to limit the spread of airborne viruses (e.g., a minimum ratio people to filtration vents and/or windows that provide fresh air). Further, the one or more constraints may be based at least in part on one or more user preferences. For example, the user may provide input to a user interface of the system that presents a questionnaire to the user requesting the user to answer questions relating the number of employees that may occupy the area associated with the floorplan, the number of offices, and/or the collaboration preferences of the user.

As part of determining whether the floorplan meets one or more constraints the system may access constraint data that is associated with one or more constraints for the area. Further the one or more constraints may be associated with occupancy of the area. The one or more constraints may include a minimum number of employees that the area may accommodate, a minimum number of rooms that the area may contain, a set of geographic locations in which the area may be located, a minimum or maximum amount of space per employee. Further, the one or more constraints may comprise a minimum layout size, a maximum layout size, an employee count, and/or a workspace per employee.

The one or more constraints may be based at least in part on one or more user inputs received via a graphical user interface. Further, the one or more user inputs may correspond to one or more user layout preferences. For example, the one or more user inputs may indicate a preferred number of rooms for a layout or a minimum number of break rooms.

Determining whether the floorplan meets one or more constraints may comprise generating a parametric model of the floorplan and applying the one or more constraints to the parametric model. For example, the parametric model may include a list of parameters and parameter values that correspond to various geometric and/or spatial attributes that meet the one or more constraints. For example, if the floorplan indicates that the area is two-thousand (2,000) square feet, the parametric model may not include any combination of length and width that may result in an area that is greater than two-thousand (2,000) square feet.

In some embodiments, applying the one or more constraints to the parametric model may comprise using the one or more constraints to determine a geometric configuration for the floorplan, one or more positions of objects within the floorplan, or one or more room types within the floorplan.

At 1008, based on the system determining that the floorplan meets the one or more constraints, the system may at 1010 generate and/or determine, based at least in part on the floorplan, a zoning map. The zoning map may comprise a plurality of light zones and/or a plurality of functional zones. The plurality of light zones may be associated with a distribution of light throughout the floorplan. The plurality of functional zones may be associated with types of activity (e.g., activity within a portion of the floorplan). In some embodiments, the zoning map may be based on one or more layout factors (e.g., the layout factors discussed with respect to FIG. 8). Based on the system determining that the floorplan does not meet the one or more constraints, the system may return to 1002 and access image data (e.g., image data associated with a different image).

The light zones map may take the form of a heatmap that indicates the amount of light that is cast on different portions of the floorplan. The light zones map may be based on factors including the positions of windows within the floorplan, the geographic location of the area associated with the floorplan, and/or the orientation of the floorplan relative to light sources (e.g., whether windows of the floorplan face the morning sun).

In some embodiments, determining the plurality of light zones may include determining, based at least in part on the floorplan, one or more locations of one or more light sources in the area. The one or more light sources may comprise lighting fixtures, doors, and/or windows.

At 1010, the system may determine, based at least in part on the zoning map, a plurality of spatial zones corresponding to the plurality of light zones and/or the plurality of functional zones. The plurality of spatial zones may correspond to the amount of light (e.g., natural light and/or artificial light) within each of the plurality of light zones and/or to the location of functional elements within each of the plurality of functional zones (e.g., plumbing and/or electrical wiring). The plurality of spatial zones may be associated with a plurality of dynamic zones. The plurality of dynamic zones may be based on the usage of the plurality of spatial zones including dynamic zone types associated with the size of a spatial zone, the types of personnel that may use a spatial zone, and/or the authorization that is required for a person to use a spatial zone.

The plurality of spatial zones may include the plurality of dynamic zones comprising one or more dynamic work zones, one or more dynamic team zones, and/or one or more dynamic community zones. The one or more dynamic work zones may comprise work zones that are used as individual work spaces (e.g., an office), the one or more dynamic team zones may comprise work zones that are used as conference rooms or meeting areas, and the one or more dynamic community zones may include areas that are communal in nature and may comprise break rooms, recreation areas, and/or foyers.

In some embodiments, determining the plurality of spatial zones may comprise determining, based at least in part on the zoning map, one or more high light level zones, one or more medium light level zones, one or more low light level zones, and/or one or more dark zones (e.g., a portion of the floorplan that does not receive direct natural light). Determination of the one or more high light level zones, one or more medium light level zones, one or more low light level zones, and/or one or more dark zones may be based on accessing the zoning map. The zoning map may indicate an amount of natural light and/or artificial light that is cast on each of a plurality of regions of the floorplan. For example, the zoning map may indicate how much light is cast on each square meter of the floorplan. The amount of light may be associated with a brightness value (e.g., a brightness value in lux, lumens, candelas, or nits) and the distinction between the one or more low light level zones, one or more medium light level zones, one or more high light level zones, and one or more dark zones may be based on the amount of light being within a corresponding brightness value range.

Further, the system may determine that the one or more high light level zones correspond to the one or more dynamic work zones, the one or more medium light level zones correspond to the one or more team work zones, and/or the one or more low light level zones correspond to the one or more dynamic community zones.

In some embodiments, the zoning map may indicate one or more amounts of natural light within one or more portions of the floorplan (e.g., light from the sun) or one or more amounts of artificial light within one or more portions of the floorplan (e.g., light from one or more lamps).

In some embodiments, generating the zoning map may be based at least in part on the application of one or more surrogate modelling techniques to the floorplan. For example, the geographic location of the floorplan may be determined and the one or more surrogate modelling techniques may include a digital twin technique in which a three-dimensional model of the geographic area (e.g., an urban area including buildings surrounding the location of the floorplan) may be used. Using a surrogate modelling technique may result in a reduction in the amount of computing resources that are used to model the distribution of light throughout a floorplan.

At 1012, the system may determine and/or generate, based at least in part on the plurality of spatial zones, a plurality of candidate floorplan layouts. The plurality of candidate floorplan layouts may comprise different configurations of the plurality of spatial zones. For example, the system may determine ten-thousand (10,000) candidate floorplan layouts in which the plurality of spatial zones are arranged in different positions within the floorplan.

At 1014, the system may select a subset of candidate floorplan layouts from the plurality of candidate floorplan layouts. Selection of the subset of candidate floorplan layouts may be based at least in part on application of one or more metaheuristic algorithms and/or one or more machine learning models (e.g., the one or more machine learning models 210 that are described with respect to FIG. 2) to the plurality of candidate floorplan layouts. The one or more metaheuristic algorithms may be configured to select the subset of candidate floorplan layouts based at least in part on one or more criteria. For example, the one or more metaheuristic algorithms may comprise a genetic algorithm that may test the fitness of various candidate floorplan layouts based on fitness criteria that are used to eliminate candidate floorplan layouts that do not meet the fitness criteria. The application of the genetic algorithm may be performed iteratively such that the number of candidate floorplan layouts is reduced after each iteration. In some embodiments, the one or more fitness criteria may be weighted. Further, the plurality of layout scores may be based at least in part on the weighting of the one or more fitness criteria.

Selection of the subset of candidate floorplan layouts may comprise determining, based at least in part on the application of the genetic algorithm to the plurality of candidate floorplan layouts, a plurality of layout scores for the plurality of candidate floorplan layouts. In some embodiments, the plurality of candidate floorplan layouts that meet the one or more criteria to a greater extent may be positively correlated with the plurality of layout scores. For example, a higher layout score may correspond to a fitter or more suitable layout than a lower layout score. Further, the system may select the subset of candidate floorplan layouts that correspond to the plurality of layout scores that meet one or more criteria. The layout criteria may include flow, congestion, and/or adjacency criteria.

Determining the plurality of layout scores for the plurality of candidate floorplan layouts may comprise determining a plurality of metrics corresponding to the plurality of candidate floorplan layouts. Further, the system may compare the plurality of metrics to a corresponding plurality of evaluation criteria. The system may also determine the plurality of layout scores based at least in part on an extent to which the plurality of metrics meet the one or more criteria.

In some embodiments, a fitness function of the genetic algorithm may be used to evaluate the plurality of candidate floorplan layouts based at least in part on fitness criteria associated with layout congestion, adjacency preferences, view preferences, and/or layout circulation.

In some embodiments, selecting the subset of candidate floorplan layouts may comprise accessing a layout tree that may comprise a plurality of nodes respectively associated with layout features of the plurality of candidate floorplan layouts. For example, the layout tree may comprise a plurality of nodes that are associated with layout features associated with the plurality of candidate floorplan layouts.

Traversing the layout tree may be based at least in part on one or more objectives of the genetic algorithm. For example, the one or more objectives of the genetic algorithm may be associated with particular layout features (e.g., wide hallways or a large main conference room) and the system may traverse the layout tree based on maximizing the number of layout features that are closest to meeting the one or more objectives.

In some embodiments, selecting the subset of candidate floorplan layouts may be based at least in part on traversal of the layout tree to a leaf node. For example, the leaf nodes of the layout tree may represent a set of layout features for one of the plurality of candidate floorplan layouts. The set of layout features that are closest to meeting the one or more objectives may correspond to the subset of candidate floorplan layouts.

In some embodiments, the genetic algorithm may comprise a multi-objective genetic algorithm. Further, the multi-objective genetic algorithm may use objectives associated with the maximizing space per employee and/or the amount of light distributed throughout a layout to determine the subset of candidate floorplan layouts.

In some embodiments, selection of the subset of candidate floorplan layouts from the plurality of layouts may comprise using one or more machine-learning value networks that were configured and/or trained to select the subset of candidate floorplan layouts based at least in part on previous user selected candidate floorplan layouts.

At 1016, the system may generate floorplan layout data comprising a subset of floorplan layouts for use by a design application. The floorplan layout data may be based at least in part on the subset of candidate floorplan layouts. For example, the floorplan layout data may be formatted for use by a design application (e.g., a computer assisted design application) and may include information that allows the floorplan layout data to be used to generate the subset of candidate floorplan layouts. Further, floorplan layout data may be used to generate a visual representation of the subset of candidate floorplan layouts that may be presented on a display output device configured to show images of the subset of candidate floorplan layouts.

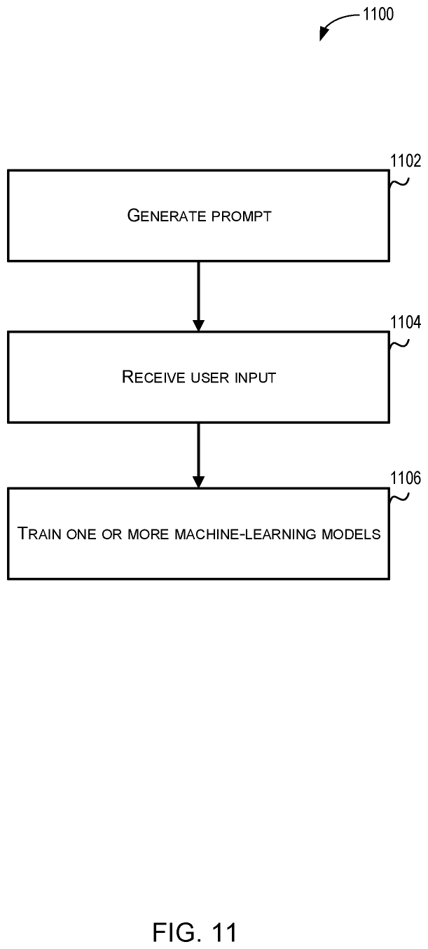

FIG. 11 illustrates a flowchart of an example method 1100 to receive user input to train a machine-learning model. The method 1100 may be performed by any suitable computing device (e.g., the workstation 141 that is described with respect to FIG. 1 and/or the computing device 200 that is described with respect to FIG. 2) and/or combination of computing devices, and is referred to herein as the system implementing the method 1100.

At 1102, the system may generate a prompt for a user to select at least one of the plurality of candidate floorplan layouts. For example, the output may generate the prompt “PLEASE SELECT ONE OF THE CANDIDATE FLOORPLAN LAYOUTS.”

At 1104, the system may receive a user input to select at least one of the subset of candidate floorplan layouts. For example, a user may provide the user input via a graphical user interface that includes images of the subset of candidate floorplan layouts. The user input to select at least one of the subset of candidate floorplan layouts may include the user touching a portion of a touchscreen display corresponding to a candidate floorplan layout is displayed and/or using an input device (e.g., a mouse or stylus) to select a candidate floorplan layout.

At 1106, the system may train one or more machine-learning models based at least in part on the subset of candidate floorplan layouts corresponding to the user input. For example, the one or more machine-learning models may be configured to generate the plurality of candidate floorplan layouts based at least in part on training data comprising the user input, the floorplan, and/or the one or more constraints. Over time, in response to multiple user inputs selecting different candidate floorplan layouts, the one or more machine-learning models may be trained to more effectively determine the types of floorplan layouts that meet the user's preferences.

In some embodiments, the output may comprise at least one three-dimensional model of at least one of the subset of candidate floorplan layouts or at least one visual space plan of at least one of the subset of candidate floorplan layouts. For example, the system may render a three-dimensional model of three (3) candidate floorplan layouts that a user may be provided with via a display output device.

Finally, this disclosure contemplates and discloses a non-transitory computer-readable storage medium having computer-executable program instructions stored thereon that when executed by a processor, cause the processor to perform one or more of the method steps described above. Moreover, this disclosure contemplates and discloses an apparatus comprising: (1) a processor, and (2) a memory having stored therein computer executable instructions, that when executed by the processor, cause the apparatus to perform one or more of the method steps described above.

What is claimed is:

1. A computer-implemented method of automatically generating floorplan layouts, the computer-implemented method comprising:
accessing, by a computing device comprising one or more processors, image data comprising an image of an area;
determining, by the computing device, based at least in part on the image data, a floorplan of the area;
determining, by the computing device, whether the floorplan meets one or more constraints associated with occupancy of the area;
based on the floorplan meeting the one or more constraints, generating, by the computing device, based at least in part on the floorplan, a zoning map comprising a plurality of light zones and a plurality of functional zones, wherein the plurality of light zones are associated with a distribution of light throughout the floorplan, and wherein the plurality of functional zones are associated with types of activity;
determining, by the computing device, based at least in part on the light zones map, a plurality of spatial zones associated with a plurality of dynamic zone types and corresponding to the plurality of light zones;
determining, by the computing device, based at least in part on the plurality of spatial zones, a plurality of candidate floorplan layouts comprising different configurations of the plurality of spatial zones;
selecting, by the computing device, based at least in part on application of one or more metaheuristic algorithms to the plurality of candidate floorplan layouts, a subset of candidate floorplan layouts from the plurality of candidate floorplan layouts, wherein the one or more metaheuristic algorithms are configured to select the subset of candidate floorplan layouts based at least in part on one or more criteria; and
generating, by the computing device, based at least in part on the subset of candidate floorplan layouts, floorplan layout data comprising a subset of floorplan layouts for use by a design application.

2. The computer-implemented method of claim 1, wherein the determining, by the computing device, based at least in part on the image data, a floorplan of the area comprises:
determining, by the computing device, the floorplan based at least in part on application of one or more object detection techniques to the image data, wherein the one or more object detection techniques are configured to detect one or more objects comprising one or more walls, one or more doors, or one or more windows.

3. The computer-implemented method of claim 1, wherein the determining, by the computing device, whether the floorplan meets one or more constraints comprises:
generating, by the computing device, a parametric model of the floorplan; and
applying, by the computing device, the one or more constraints to the parametric model, wherein the applying, by the computing device, the one or more constraints to the parametric model comprises using the one or more constraints to determine a geometric configuration for the floorplan, one or more positions of objects within the floorplan, or one or more room types within the floorplan.

4. The computer-implemented method of claim 1, wherein the generating, by the computing device, based at least in part on the light zones map, a plurality of spatial zones associated with a respective plurality of dynamic zone types and corresponding to the plurality of light zones comprises:
determining, by the computing device, based at least in part on the light zones map, the plurality of spatial zones comprising one or more high light level zones, one or more medium light level zones, and one or more low light level zones; and
determining, by the computing device, that the one or more high light level zones correspond to one or more dynamic work zones, the one or more medium light level zones correspond to one or more dynamic team zones, and the one or more low light level zones correspond to one or more dynamic community zones.

5. The computer-implemented method of claim 1, wherein the light zones map indicates one or more amounts of natural light within one or more portions of the floorplan or one or more amounts of artificial light within the one or more portions of the floorplan.

6. The computer-implemented method of claim 1, wherein the selecting, by the computing device, based at least in part on application of the one or more metaheuristic algorithms to the plurality of candidate floorplan layouts, a subset of candidate floorplan layouts from the plurality of candidate floorplan layouts comprises:
determining, by the computing device, the subset of candidate floorplan layouts based at least in part on use of one or more machine-learning value networks configured to select the subset of candidate floorplan layouts based at least in part on previous user selected candidate floorplan layouts.

7. The computer-implemented method of claim 1, wherein the selecting, by the computing device, based at least in part on application of the one or more metaheuristic algorithms to the plurality of candidate floorplan layouts, a subset of candidate floorplan layouts from the plurality of candidate floorplan layouts comprises:
determining, by the computing device, based at least in part on the application of the one or more metaheuristic algorithms to the plurality of candidate floorplan layouts, a plurality of layout scores for the plurality of candidate floorplan layouts; and
selecting, by the computing device, the subset of candidate floorplan layouts that correspond to the plurality of layout scores that meet the one or more criteria.

8. The computer-implemented method of claim 7, wherein the determining, by the computing device, based at least in part on the application of the one or more metaheuristic algorithms to the plurality of candidate floorplan layouts, a plurality of layout scores for the plurality of candidate floorplan layouts comprises:
determining, by the computing device, a plurality of metrics corresponding to the plurality of candidate floorplan layouts;
comparing, by the computing device, the plurality of metrics to the one or more criteria; and
determining, by the computing device, the plurality of layout scores based at least in part on an extent to which the plurality of metrics meet the one or more criteria.

9. The computer-implemented method of claim 7, wherein a fitness function of the one or more metaheuristic algorithms is used to evaluate the plurality of candidate floorplan layouts based at least in part on the one or more criteria associated with layout congestion, adjacency preferences, view preferences, or layout circulation.

10. The computer-implemented method of claim 7, wherein the plurality of candidate floorplan layouts that meet the one or more criteria to a greater extent are positively correlated with the plurality of layout scores.

11. The computer-implemented method of claim 7, wherein the one or more criteria are weighted, and wherein the plurality of layout scores are based at least in part on the weighting of the one or more criteria.

12. The computer-implemented method of claim 1, wherein the selecting, by the computing device, based at least in part on application of the one or more metaheuristic algorithms to the plurality of candidate floorplan layouts, a subset of candidate floorplan layouts from the plurality of candidate floorplan layouts comprises:
accessing, by the computing device, a layout tree comprising a plurality of nodes respectively associated with layout features of the plurality of candidate floorplan layouts;
traversing, by the computing device, the layout tree based at least in part on one or more objectives of the one or more metaheuristic algorithms; and
selecting, by the computing device, the subset of candidate floorplan layouts based at least in part on traversal of the layout tree to a leaf node.

13. The computer-implemented method of claim 1, further comprising:
generating, by the computing device, a prompt for a user to select at least one of the plurality of candidate floorplan layouts;
receiving, by the computing device, a user input to select at least one of the subset of candidate floorplan layouts; and
training, by the computing device, one or more machine-learning models based at least in part on the subset of candidate floorplan layouts corresponding to the user input, wherein the one or more machine-learning models are configured to generate the plurality of candidate floorplan layouts based at least in part on training data comprising the floorplan, the one or more constraints, and the user input.

14. The computer-implemented method of claim 1, wherein the generating, by the computing device, based at least in part on the floorplan, a light zones map comprising a plurality of light zones associated with a distribution of light throughout the floorplan comprises:
determining, by the computing device, the light zones map based in part on application of one or more surrogate modelling techniques to the floorplan.

15. One or more non-transitory computer readable media comprising instructions that, when executed by at least one processor, cause a computing device to perform operations comprising:
accessing image data comprising an image of an area;
determining, based at least in part on the image data, a floorplan of the area;
determining whether the floorplan meets one or more constraints associated with occupancy of the area;
based on the floorplan meeting the one or more constraints, generating, based at least in part on the floorplan, a light zones map comprising a plurality of light zones associated with a distribution of light throughout the floorplan;
determining, based at least in part on the light zones map, a plurality of spatial zones associated with a plurality of dynamic zone types and corresponding to the plurality of light zones;
determining, based at least in part on the plurality of spatial zones, a plurality of candidate floorplan layouts comprising different configurations of the plurality of spatial zones;
selecting, based at least in part on application of one or more metaheuristic algorithms to the plurality of candidate floorplan layouts, a subset of candidate floorplan layouts from the plurality of candidate floorplan layouts, wherein the one or more metaheuristic algorithms are configured to select the subset of candidate floorplan layouts based at least in part on one or more criteria; and
generating, based at least in part on the subset of candidate floorplan layouts, floorplan layout data comprising a subset of floorplan layouts for use by a design application.

16. The one or more non-transitory computer readable media of claim 15, wherein the one or more metaheuristic algorithms comprise a multi-objective genetic algorithm, a simulated annealing algorithm, a particle swarm optimization algorithm, or a Monte Carlo algorithm.

17. The one or more non-transitory computer readable media of claim 15, wherein the one or more constraints further comprise a minimum layout size, a maximum layout size, an employee count, or a workspace per employee.

18. A system comprising:
a computing device comprising:
one or more processors; and
memory storing instructions that, when executed by the one or more processors, cause the computing device to:
access image data comprising an image of an area;
determine, based at least in part on the image data, a floorplan of the area;
determine whether the floorplan meets one or more constraints associated with occupancy of the area;
based on the floorplan meeting the one or more constraints, generate, based at least in part on the floorplan, a light zones map comprising a plurality of light zones associated with a distribution of light throughout the floorplan;
determine, based at least in part on the light zones map, a plurality of spatial zones associated with a plurality of dynamic zone types and corresponding to the plurality of light zones;
determine, based at least in part on the plurality of spatial zones, a plurality of candidate floorplan layouts comprising different configurations of the plurality of spatial zones;
select, based at least in part on application of one or more machine-learning models to the plurality of candidate floorplan layouts, a subset of candidate floorplan layouts from the plurality of candidate floorplan layouts, wherein the one or more machine-learning models are configured to select the subset of candidate floorplan layouts based at least in part on one or more criteria; and
generate, based at least in part on the subset of candidate floorplan layouts, floorplan layout data comprising a subset of floorplan layouts for use by a design application.

19. The system of claim 18, wherein the one or more constraints are based at least in part on one or more user inputs received via a graphical user interface, and wherein the one or more user inputs correspond to one or more user layout preferences.

20. The system of claim 18, wherein the floorplan layout data comprises at least one three-dimensional model of at least one of the subset of candidate floorplan layouts or at least one visual space plan of at least one of the subset of candidate floorplan layouts.
